(19) United States
(12) Patent Application Publication
(10) Pub. No.: US 2004/0111255 A1
(43) Pub. Date: Jun. 10, 2004

(54) Graph-based method for design, representation, and manipulation of NLU parser domains

(75) Inventors: Juan Manuel Huerta, Hawthorne, NY (US); David Lubensky, Brookfield, CT (US)

Correspondence Address: DUKE. W. YEE, CARSTENS, YEE & CAHOON,L.L.P., P.O. BOX 802334, DALLAS, TX, 75380, US

(73) Assignee: International Business Machines Corporation, Armonk, NY

(21) Appl. No.: 10/315,858

(22) Filed: Dec. 10, 2002

(51) Int. Cl. G06F 17/27; G06F 17/21

(52) U.S. Cl. 704/10

(57) ABSTRACT

A toolkit is provided for allowing a user to represent a domain for a natural language understanding application. The toolkit allows a user to create a graph that represents a domain. An NLU parser domain may be represented by a single graph, which includes one start node and one end node. Each utterance in the domain will traverse the graph from the start node to the end node. The user may then manipulate the graph to add or delete nodes and arcs. The user may also create subgraphs for subdomains. The toolkit allows the user to merge subdomains to create a larger domain or to remove paths from a start node to an end node to remove subcomponents of a domain. The single graph approach of the present invention also provides a visual representation of a domain to assist a developer in annotating training sentences.

### BACKGROUND OF THE INVENTION

1. Technical Field

The present invention relates to Automatic Natural Language Understanding (NLU), and more particularly relates to a method to represent and manipulate the syntactic and semantic labels of a parser or task in a Dialog based NLU system.

2. Description of Related Art

Natural Language Understanding (NLU) technology is a fundamental component of dialog-based automatic speech understanding systems. Such systems are typically implemented on telephony platforms and are used to automate the communication between humans and machines through natural speech. Besides the NLU component, a speech understanding system typically includes a speech recognition module whose purpose is to transform the speech uttered by the user into strings of words that are then used by the NLU component to extract meaning. The goal of the NLU component is to identify and delimit (i.e., to label) the elements of the speech transcription that carry information that is relevant to the system's task. For example, an Air Travel Reservation NLU system would extract from the user's speech information on the desired departure and arrival destinations, preferred times and dates for the travel, etc. This set of relevant semantic labels are called the attributes of a domain.

Current state of the art NLU systems extract the attributes of a domain by means of a parser. The parser annotates or labels a sentence by “bracketing” it using the labels in its inventory. For example, the following sentence illustrates the transcription of a sentence in the example Air Travel reservation domain.

Sentence: “I want information on flights departing from Houston tomorrow morning”

[!S! I want [air-info information on [dep flights departing from [city Houston city] [date tomorrow date] [time morning time] dep] air-info] !S!]

Under the sentence is shown the bracketed sentence where the labels used in the annotation are the terms in italic font (i.e., !S!, air-info, dep-flights, city, date, and time).

A parser can be implemented in different ways, but regardless of implementation, the goal of the parser is to produce a mapping between the user's speech and the set of attributes in the domain. When the elements of the parser used in bracketing (labels) are semantic components of the task, the parser is referred to as a semantic parser. In practice, a parser's label set might also include syntactic elements as well as semantic ones. The role of the syntactic elements is to aid in the differentiation or disambiguation of words and phrases whose meaning is determined by their context or syntactic role in the utterance. For example, in the following sentence, “transfer” is deemed to be an action (verb) while “checking” is deemed to be an account (noun). p1 Sentence “I want to transfer one hundred dollars to my checking”

[!S! I want to [bank-action [action transfer action] [ammnt one hundred dollars ammnt] [target-acct to my checking target-acct] bank-action] !S!]

Many currently used semantic parsers employ statistical methods to perform their task and thus, need to be trained. The training process normally requires the collection and annotation, labeling or bracketing of large pools of training data (i.e., domain sentences). Sets of annotated sentences usually are referred to as treebanks, as the parsing (whether semantic or syntactic) of each individual sentence is represented by a tree. Typically, the tree's (i.e., a directed acyclical graph) set of nodes includes the semantic and sometimes syntactic labels of the domain, and the leaves (terminal nodes) are directly related to the uttered words. The elements under a given pair of brackets (words and labels) form a subtree under the corresponding node.

In the prior art there have been tools and methods to manipulate the treebanks. These tools represent each sentence and its tree individually, and the annotator sequentially navigates through the treebank one sentence at a time. The developer then might bracket the data and construct a tree per sentence, by means of a point and click interface. Other approaches have been similar to this one with the exception that the sentences are represented as bracketed text entities. In other words, the sentences are not represented graphically, but instead, are represented as text with brackets that denote regions encompassed by labels/elements in the text sentence. However, the relationship between the complete annotated corpus, and a concise and parsimonious representation of the parser domain (labels) and their interrelationships is missing from this approach.

Other approaches describe a domain by its ontology (i.e., a formal description of concepts and their relationships usually expressed in terms of axioms or rules), but do not associate the domain with a NLU parser or its labels, do not include syntactical relationships designed to aid parsing or resolve ambiguities, and do not associate graphs with the ontologies. Thus such ontologies aim at representing all feasible abstract semantic and conceptual relationships in a domain regardless of whether these relationships are implementable or usable for parsing and annotation of speech data using bracketing. Therefore, ontologies can parsimoniously represent a semantic or task domain, but are not directly applied to parser design and more specifically, are not currently represented in a directed acyclic graph using semantic labels associated to a NLU parser.

In view of the above, there is a need for a representation in which a developer can design, visualize and manipulate, in one entity, the components of the domain and their immediate interrelationships as they exist in the parser corpora of spoken speech, as well as how the annotated data in the corpus populates and relates to this representation.

### SUMMARY OF THE INVENTION

The present invention provides a toolkit for allowing a user to represent a domain for a natural language understanding application. The toolkit allows a user to create a graph that represents a domain. An NLU parser domain may be represented by a single graph, which includes one start node and one end node. Each utterance in the domain will traverse the graph from the start node to the end node. The user may then manipulate the graph to add or delete nodes and arcs. The user may also create subgraphs for subdomains. The toolkit allows the user to merge subdomains to create a larger domain or to remove paths from a start node to an end node to remove subcomponents of a domain. The single graph approach of the present invention also provides a visual representation of a domain to assist a developer in annotating training sentences.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is an example graph of a domain of an NLU application in accordance with a preferred embodiment of the present invention;

FIG. 4 is an example graph with relative label co-occurrence information in accordance with a preferred embodiment of the present invention;

FIGS. 5A-5C illustrate example graphs being combined to form a single graph representing the domain of an NLU application in accordance with a preferred embodiment of the present invention;

FIG. 6 depicts an example of a graph that represents a car reservation NLU application in accordance with a preferred embodiment of the present invention;

FIG. 7 is an example graph representation of a complete Air-travel information domain created by the composition of three preexisting graphs in accordance with a preferred embodiment of the present invention;

FIG. 8 illustrates an example screen of display of a graphical user interface toolkit in accordance with a preferred embodiment of the present invention; and

FIGS. 9A and 9B is a flowchart illustrating the operation of a graphical tool for design, representation, and manipulation of NLU parser domains in accordance with a preferred embodiment of the present invention.

### DETAILED DESCRIPTION OF THE PREFERRED EMBODIMENT

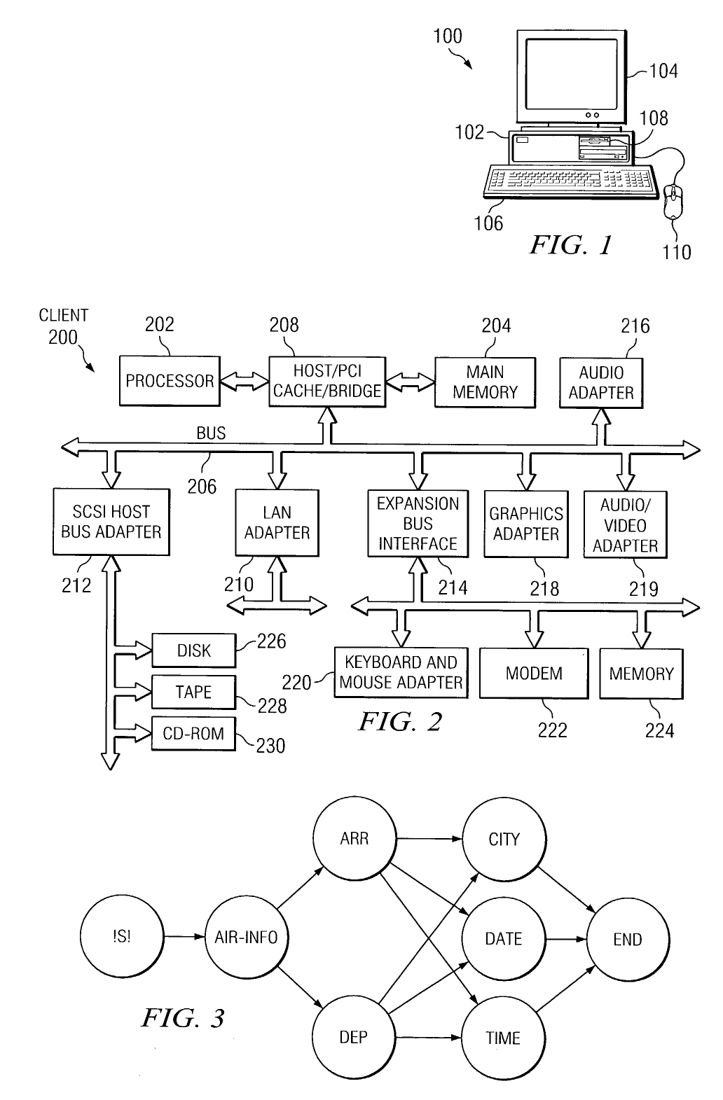

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a representation of the domain of an NLU application into a single graph, where the nodes of the graph represent the labels employed directly by the NLU parser. The nature of the labels employed may be semantic, syntactic or both. The arcs or edges of the graphs show the relationships of the labels existing in the labeled or annotated data. For every label in the parser label set, there exists a node in the graph. An edge will go from node i to node j in the graph, if and only if there is at least one instance in the treebank where label j is an immediate child of label i.

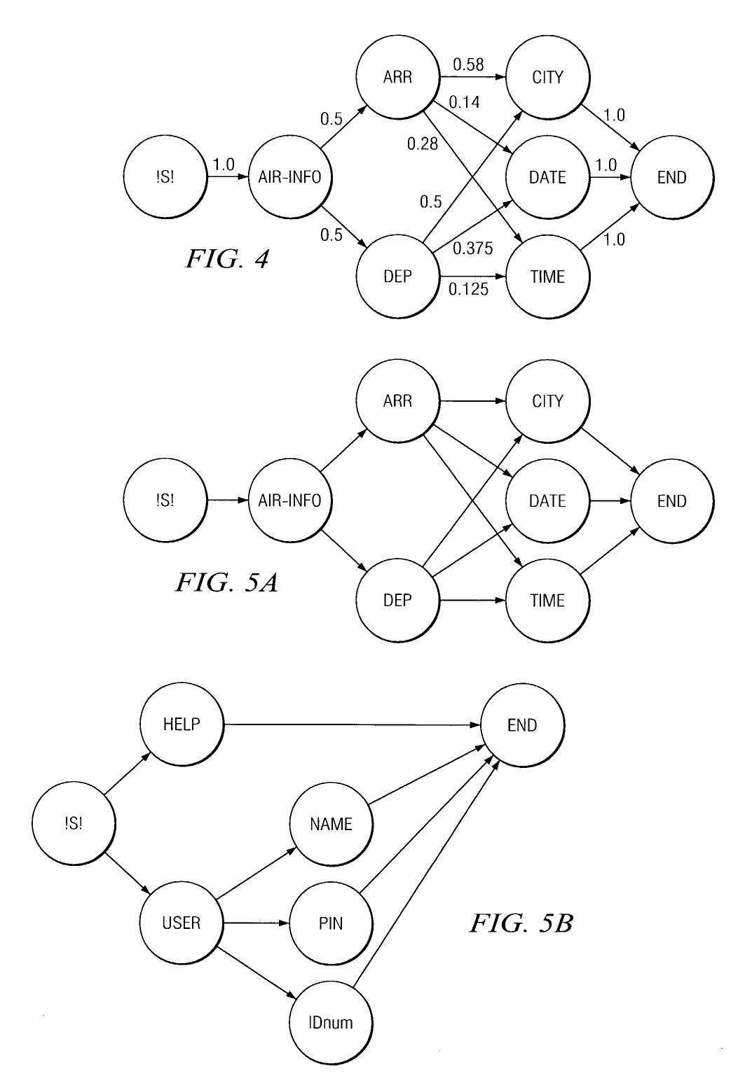

With reference now to FIG. 3, an example graph of a domain of an NLU application is shown in accordance with a preferred embodiment of the present invention. In the graph shown in FIG. 3, a node exists for every label of the small annotated corpus in that figure. An edge exists between the node “arr” and “date” but not between “air-info” and “date” because in the corpus, the label “date” occurs immediately below “arr” at least once, while “date” doesn't occur immediately under “air-info”. An example corpus of bracketed sentences that generate the graph in FIG. 3 is as follows:

[!S! I want to know of [air-info any flights [dep departing from [city New York city] [date today date] dep] air-info] !S!]

[!S! [air-info Information on the flight [dep from [city London city] dep] [arr to [city Pars city] arr] air-info] !S!]

[!S! [air-info What flights [arr get to [city Seattle city] [time before noon time] [date this Saturday date] arr] air-ino] !S!]

[!S! Are there any [air-info flights [arr to [city Pittsburgh city] arr] [dep from [city Boston city] departing [time after ten pm time] [date on Saturday date] dep] air-info] !S!]

[!S! [air-info flights [dep from [city Chicago city] dep] [arr to [city Houston city] arr] [dep leaving [date Sunday date] [time morning time] [arr arriving [time before noon time] arr] air-info] !S!]

In this way, the labels occurring in a corpus and their immediate interrelationships can represented in a single graph. The root label (represented in this case by “!S!”) is the typical starting node of the graph. The terminal labels, whose children include no labels, only words, will correspond to nodes in the graph having a single outgoing arc that will go to the ending node, represented in this case by “END.” In other words, if a label produces no further labels it will have a node in the graph that is connected to END.

The resulting graph represents both information that is normally described in an ontology of the domain (i.e., the semantic components and their relationships), as well as information supporting syntactical structures and the hierarchical organization of such structures. This is a rich representation of the domain which allows the designer to understand and visualize the semantic interrelations in the domain and the structures (syntax) in which they occur.

With reference now to FIG. 4, an example graph is shown with relative label co-occurrence information in accordance with a preferred embodiment of the present invention. More specifically, assuming node i produces n occurrences of children in the corpus, the arc between node i and node j will be labeled with the percentage of the total occurrences of children which are j. For example, if one third of the children produced by node i are labels j and the other two thirds of the child instances of children of i are labeled k, then the arcs i-j and i-k are labeled 0.333 and 0.666 respectively. The graph can display such arc weights, as in FIG. 4, or can omit them, as in FIG. 3.

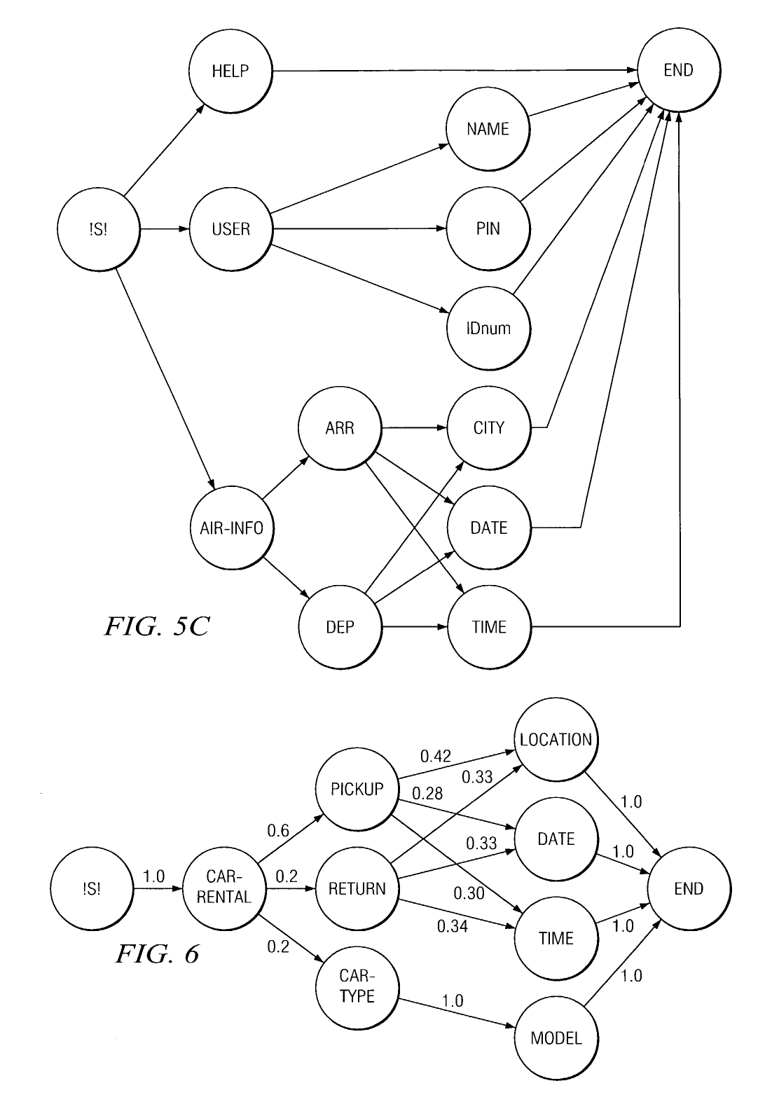

FIGS. 5A-5C illustrate example graphs being combined to form a single graph representing the domain of an NLU application in accordance with a preferred embodiment of the present invention. FIGS. 5A and 5B show a decomposition of such domain into two graphs. FIG. 5A representing the domain-specific part of the graph, the Air travel information component. FIG. 5B representing the general customer support part of the graph, help and login in this case.

The composition of the graphs in FIGS. 5A and 5B produce the overall graph in FIG. 5C, which shows a graph representation of a complete Air-travel information domain supporting both domain transactions and general transactions, such as “help” and “login.” The transaction oriented part of the domain is domain independent; therefore, it may be considered an isomorphism of a general transaction graph which can be employed across many different domains to support the transaction based speech that might appear in the corpus. Representing a domain in the manner described above allows the developer of the domain to handle both components independently: the transaction-oriented graph (or any isomorphism of this graph) and the domain specific graph. The single-graph technique of the present invention allows an NLU technology provider to deliver prepackaged and prebuilt models to the NLU developer which can be manipulated by graphs and subgraphs.

It is to be understood that several techniques to implement statistical parsers are know in the art, and that the present invention can be employed independently of parser technology, be it statistical or otherwise. The single-graph representation of the present invention facilitates the developer of such a parser with a method to design, represent, visualize and manipulate the domain that the parser will handle regardless of the exact algorithmic nature of the parser. Graphs of this nature allow the developer to decompose the domain into subgraphs that can be handled and manipulated independently. The configuration of the labels shown so far in FIGS. 3, 4, and 5A-5C are but a few examples of the many types and styles of parsers that can be associated with the technique of the present invention.

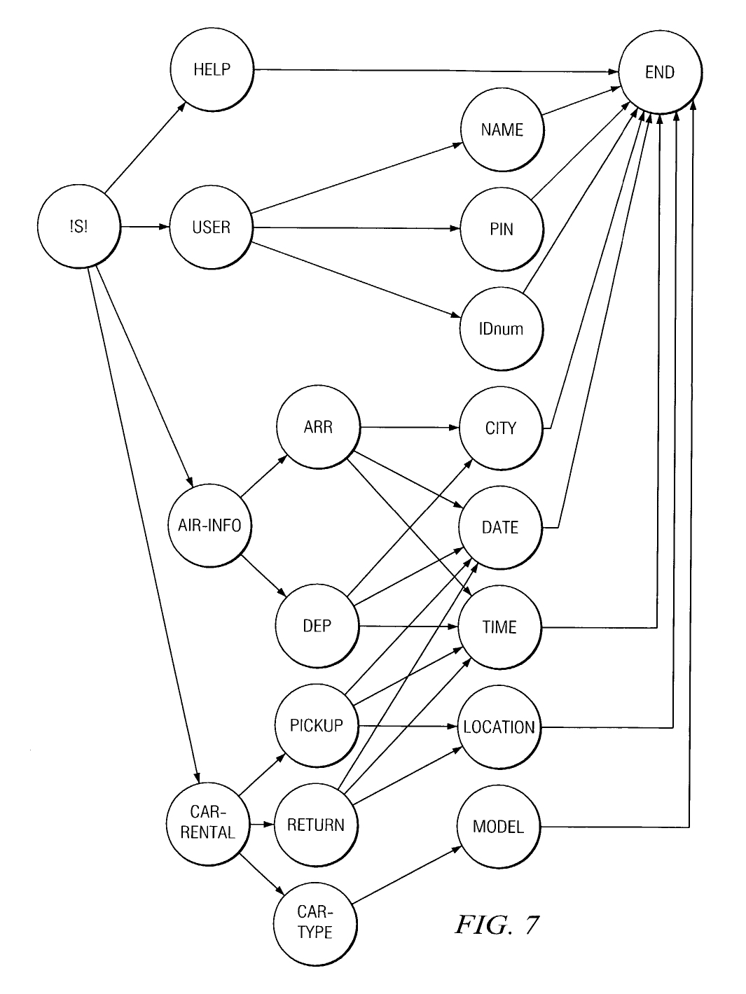

As a further example, FIG. 6 depicts an example of a graph that represents a car reservation NLU application in accordance with a preferred embodiment of the present invention. The edges of the graph are labeled with the elements employed by the parser to bracket the data. The initial node !S! denotes the root of the parse trees in the treebank, and is the initial node in the graph. The weights in the graph correspond to the relative frequencies of occurrence in the graph. An example corpus of bracketed sentences that generate the graph in FIG. 6 is as follows:

[!S! [car-rental I need a car [pickup [location in Pittsburgh location] [date this Sunday date] pickup] car-rental] !S!]

[!S! [car-rental [pickup Pickup [location in Orlando location] [date this Saturday date] [time at twelve noon time] pickup] car-rental] !S!]

[!S! [car-rental [return Return [location in Miami location] [date the day after date] [time at the same time time] return] car-rental] !S!]

[!S! [car-rental I would like to get [car-type [model a Mustang model] car-type] [pickup [location at JFK location] [date today date] [time at eight pm time] pickup] car-rental] !S!]

Turning now to FIG. 7, an example graph representation of a complete Air-travel information domain created by the composition of three preexisting graphs is shown in accordance with a preferred embodiment of the present invention. The general transaction graph and the air travel graphs of FIGS. 5A and 5B are combined with the graph shown in FIG. 6. This example illustrates how easily new domains can be designed and their graphs composed by merging their graphs. The nodes of the three composing graphs are included in the new graph and the edges of the new graphs correspond to the edges of the conforming graphs. The new corresponding parser, after training, would be able to parse the new “air-travel information with car rental” domain.

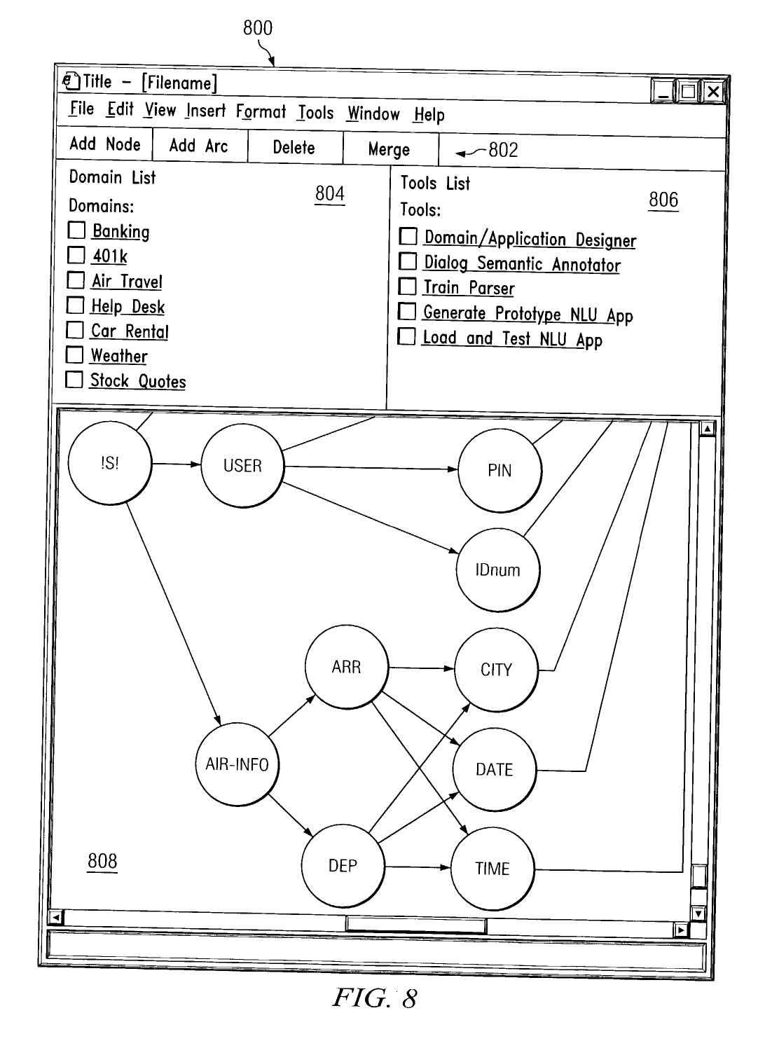

FIG. 8 illustrates an example screen of display of a graphical user interface toolkit in accordance with a preferred embodiment of the present invention. The graphical user interface (GUI) is utilized to manipulate (i.e., create, insert, delete, and move) the labels of the domain, as well as the interconnections (i.e., the edges) of the graph. The GUI toolkit screen comprises window 800, including a title bar, a menu bar, and button toolbar 802, which includes “Add Node,” “Add Arc,” “Delete,” and “Merge” buttons.

The GUI toolkit window also includes display area includes a domain list display area 804, which displays a list of existing domain graphs, tools list display area 806, which displays a list of NLU parser tools, and graph display area 808, which displays a graph representation of one or more domains. A user may identify existing domains for display in graph display area 808, such as by selecting a domain from domain list display area 804. The user may also create a new graph by, for example, selecting a “New” command from the “File” menu in the menu bar.

One or more domain graphs are then displayed in display area 808 to be viewed or manipulated by the user. The user may then add nodes, add arcs, delete nodes, delete arcs, merge graphs, move graph elements, etc., in graph display area 808. The user may perform operations on the graphs by selecting tool bar buttons, by selecting menu commands, or by other means, such as drag-and-drop operations, as known in the art. The user may also use other NLU parser tools by selecting a tool from tool list display area 806.

In an alternative embodiment, the user may be presented with the set of preexisting labels and their interconnections, such as, for example, in a panel in GUI toolkit window 800. The user may then modify existing labels and arcs or define new labels and arcs. The user may also handle subgraphs independently. Such graphs can decompose a complex NLU domain into simpler subcomponents or subdomains, each represented by its own graph.

The resulting domain graph may be stored as a data structure representing the domain. This data structure may be used to select training sentences to train an NLU parser for a specific domain. The domain graph may also be used to present the domain to customers or other developers. A customer may decide to pair down the domain by removing paths from the start node to the end node. Alternatively, the customer may use the visual representation of the domain to anticipate problems or potential enhancements. Furthermore, a visual representation of the domain may assist developers in annotating sentences in the training corpus by providing the labels and possible paths in the domain. The domain graph may be presented on a display device or by producing a hard copy of the domain graph, such as by printing using a printer device.

Those of ordinary skill in the art will appreciate that the GUI in FIG. 8 may vary depending on the implementation. Other graphical, command-line, or menu interface elements may be used in addition to or in place of the GUI elements depicted in FIG. 8. The depicted example in FIG. 8 and above-described examples are not meant to imply limitations in the implementation of the present invention. For example, a domain or subdomain may be represented by other types of language models, such as finite state language models, N-gram language models, or a combination thereof.

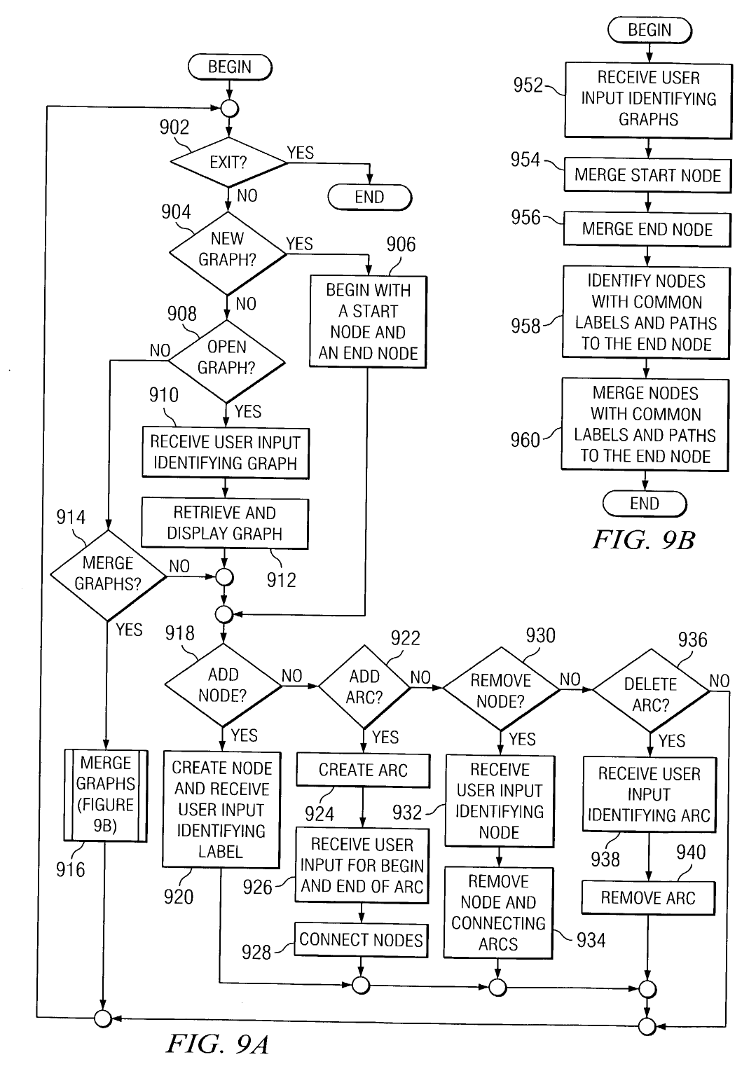

With reference now to FIGS. 9A and 9B, flowcharts illustrating the operation of a graphical tool for design, representation, and manipulation of NLU parser domains are shown in accordance with a preferred embodiment of the present invention. More particularly, with reference to FIG. 9A, the process begins and a determination is made as to whether an exit condition exists (step 902). An exit condition may exist, for example, if the user closes the graphical user interface. If an exit condition exists, the process ends.

If an exit condition does not exist in step 902, a determination is made as to whether a new graph is to be created (step 904). If a new graph is to be created, the process initializes the graph with a start node and an end node (step 906). If a new graph is not to be created in step 904, a determination is made as to whether an existing graph is to be opened (step 908). If an existing graph is to be opened, the process receives user input identifying an existing graph (step 910) and retrieves and displays the graph (step 912).

If an existing graph is not to be opened in step 908, a determination is made as to whether two or more graphs are to be merged (step 914). If graphs are to be merged, the process merges the graphs as described below with respect to FIG. 9B (step 916). After initializing a new graph in step 906, after retrieving and displaying an existing graph in step 912, and if graphs are not to be merged in step 914, the process proceeds to step 918 and a determination is made as to whether a new node is to be added to the graph. If a new node is to be added, the process creates a node and receives user input identifying a label for the node (step 920). Thereafter, the process returns to step 902 to determine whether an exit condition exists.

If a new node is not to be added in step 918, a determination is made as to whether a new arc is to be added (step 922). If an arc is to be added, the process creates an arc (step 924), receives user input for a beginning and an ending node for the arc (step 926), and connects the nodes with the arc (step 928). Then, the process returns to step 902 to determine whether an exit condition exists.

If a new arc is not to be added in step 922, a determination is made as to whether a node is to be removed (step 930). If an arc is to be removed, the process receives user input identifying a node to be removed (step 932) and removes the identified node and connecting arcs (step 934). Alternatively, the process may leave the arcs in the graph to be subsequently connected to other nodes. Next, the process returns to step 902 to determine whether an exit condition exists.

If a node is not to be removed in step 930, a determination is made as to whether an arc is to be deleted (step 936). If an arc is not to be deleted, the process returns to step 902 to determine whether an exit condition exists. Otherwise, the process receives user input identifying an arc to be deleted (step 938) and removes the identified arc (step 940).

Turning now to FIG. 9B, the operation of a graph merging process is illustrated. The process begins and receives user input identifying the graphs to be merged (step 952). Then, the process merges the start nodes of the graphs (step 954) and merges the end nodes of the graphs (step 956). Next, the process identifies nodes with common labels and common paths to the end node (step 958) and merges these nodes (step 960). Thereafter, the process ends.

Thus, the present invention provides a graph-based mechanism for the design, representation, and manipulation of NLU parser domains. Semantic and syntactic parser tags interrelationships are represented in a directed graph, either implemented in a GUI based toolkit or in a data structure, or providing tools or methods to create, visualize or manipulate such graph. Tools and methods are provided to aid in the decomposition of complex NLU domains into subgraphs representing each a subdomain and or isomorphisms between other domain graphs. Parser content may be packaged and delivered to developers in the form of pre-built models.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for providing a visual representation of a natural language understanding parser domain, the method comprising:
providing a domain graph, wherein the domain graph includes a start node, an end node, a plurality of label nodes, wherein each label node represents a label employed by a natural language understanding parser, and a plurality of directional arcs, wherein each directional arc represents a relationship between two label nodes; and
presenting the domain graph to a user.

2. The method of claim 1, further comprising:
presenting a graphical user interface for manipulating the domain graph.

3. The method of claim 2, wherein the graphical user interface includes at least one of a control for adding a label node, a control for deleting a label node, a control for adding a directional arc, and a control for deleting a directional arc.

4. The method of claim 2, wherein the graphical user interface includes a domain graph display area and wherein the step of presenting the domain graph to a user includes displaying the domain graph in the domain graph display area.

5. The method of claim 1, wherein the domain graph is a first subdomain graph, the method further comprising:
providing a second subdomain graph; and
merging the first subdomain graph and the second subdomain graph to form a merged domain graph.

6. The method of claim 5, wherein the step of merging the first subdomain graph and the second subdomain graph includes:
presenting a graphical user interface including a merge control for merging subdomain graphs; and
responsive to user selection of the merge control, merging the first subdomain graph and the second subdomain graph.

7. The method of claim 5, wherein the step of merging the first subdomain graph and the second subdomain graph includes:
merging a start node for the first subdomain graph and a start node for the second subdomain graph;
merging an end node for the first subdomain graph and an end node for the second subdomain graph;
identifying label nodes with common labels and paths to the end node in the first subdomain graph and the second subdomain graph; and
merging the identified label nodes with common labels and paths to the end node.

8. The method of claim 1, further comprising:
selecting training sentences for a natural language understanding parser based on the domain graph.

9. The method of claim 1, wherein the step of presenting the domain graph to a user includes one of displaying the domain graph on a display device and printing the domain graph on a printer device.

10. An apparatus for providing a visual representation of a natural language understanding parser domain, the apparatus comprising:
graph means for providing a domain graph, wherein the domain graph includes a start node, an end node, a plurality of label nodes, wherein each label node represents a label employed by a natural language understanding parser, and a plurality of directional arcs, wherein each directional arc represents a relationship between two label nodes; and
presentation means for presenting the domain graph to a user.

11. The apparatus of claim 10, further comprising:
interface means for presenting a graphical user interface for manipulating the domain graph.

12. The apparatus of claim 11, wherein the graphical user interface includes at least one of a control for adding a label node, a control for deleting a label node, a control for adding a directional arc, and a control for deleting a directional arc.

13. The apparatus of claim 11, wherein the graphical user interface includes a domain graph display area and wherein the presentation means includes display means for displaying the domain graph in the domain graph display area.

14. The apparatus of claim 10, wherein the domain graph is a first subdomain graph, the apparatus further comprising:
means for providing a second subdomain graph; and
merging means for merging the first subdomain graph and the second subdomain graph to form a merged domain graph.

15. The apparatus of claim 14, wherein the merging means includes:
means for presenting a graphical user interface including a merge control for merging subdomain graphs; and
means, responsive to user selection of the merge control, for merging the first subdomain graph and the second subdomain graph.

16. The apparatus of claim 14, wherein the merging means includes:
means for merging a start node for the first subdomain graph and a start node for the second subdomain graph;
means for merging an end node for the first subdomain graph and an end node for the second subdomain graph;
means for identifying label nodes with common labels and paths to the end node in the first subdomain graph and the second subdomain graph; and
means for merging the identified label nodes with common labels and paths to the end node.

17. The apparatus of claim 10, further comprising:
means for selecting training sentences for a natural language understanding parser based on the domain graph.

18. The apparatus of claim 10, wherein the presentation means includes one of display means for displaying the domain graph on a display device and printing means for printing the domain graph on a printer device.

19. A data structure, in a computer readable medium, for representing a natural language understanding parser domain, the data structure comprising:
a start node;
an end node;
a plurality of label nodes, wherein each label node represents a label employed by a natural language understanding parser; and
a plurality of directional arcs, wherein each directional arc represents a relationship between two label nodes,
wherein every utterance in the natural language understanding parser domain forms a path from the start node to the end node and traverses at least one label node.

20. A computer program product, in a computer readable medium, for providing a visual representation of a natural language understanding parser domain, the computer program product comprising:
instructions for providing a domain graph, wherein the domain graph includes a start node, an end node, a plurality of label nodes, wherein each label node represents a label employed by a natural language understanding parser, and a plurality of directional arcs, wherein each directional arc represents a relationship between two label nodes; and
instructions for presenting the domain graph to a user.
